(19) United States
(12) Patent Application Publication
(10) Pub. No.: US 2026/0064266 A1
(43) Pub. Date: Mar. 5, 2026

(54) SERVICE LEVEL BREACH PREDICTION

(71) Applicant: Dell Products L.P., Round Rock, TX (US)

(72) Inventors: Lisa O'Mahony, Cork (IE); Jason McCarthy, Cambridge, MA (US); Francisco Jaen, Cork (IE)

(73) Assignee: Dell Products L.P., Round Rock, TX (US)

(21) Appl. No.: 18/820,876

(22) Filed: Aug. 30, 2024

(51) Int. Cl. G06F 21/56

(52) U.S. Cl. CPC G06F 21/566; G06F 2221/034

(57) ABSTRACT

A method is provided, comprising: obtaining a plurality of measured response times for a given storage group, each of the measured response times corresponding to a different instance of a same time window; classifying the plurality of measured response times with a machine learning model to obtain a first predicted response time and a second predicted response time, the first predicted response time corresponding to a first future instance of the time window, and the second predicted response time corresponding to a second future instance of the time window; detecting whether the first predicted response time and the second predicted response time satisfies a service level objective for the given storage group; and generating a notification when at least one of the first predicted response time and the second predicted response time fails to satisfy the service level objective.

### BACKGROUND

A distributed storage system may include a plurality of storage devices (e.g., storage arrays) to provide data storage to a plurality of nodes. The plurality of storage devices and the plurality of nodes may be situated in the same physical location, or in one or more physically remote locations. The plurality of nodes may be coupled to the storage devices by a high-speed interconnect, such as a switch fabric.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to aspects of the disclosure, a method is provided, comprising: obtaining a plurality of measured response times for a given storage group, each of the measured response times corresponding to a different instance of a same time window; classifying the plurality of measured response times with a machine learning model to obtain a first predicted response time and a second predicted response time, the first predicted response time corresponding to a first future instance of the time window, and the second predicted response time corresponding to a second future instance of the time window; detecting whether the first predicted response time and the second predicted response time satisfies a service level objective for the given storage group; and generating a notification when at least one of the first predicted response time and the second predicted response time fails to satisfy the service level objective.

According to aspects of the disclosure, a system is provided, comprising: a memory; and at least one processor that is operatively coupled to the memory, the at least one processor being configured to perform the operations of: obtaining a plurality of measured response times for a given storage group, each of the measured response times corresponding to a different instance of a same time window; classifying the plurality of measured response times with a machine learning model to obtain a first predicted response time and a second predicted response time, the first predicted response time corresponding to a first future instance of the time window, and the second predicted response time corresponding to a second future instance of the time window; detecting whether the first predicted response time and the second predicted response time satisfies a service level objective for the given storage group; and generating a notification when at least one of the first predicted response time and the second predicted response time fails to satisfy the service level objective.

According to aspects of the disclosure, a non-transitory computer-readable medium is provided that stores one or more processor executable instructions, which, when executed by at least one processor, cause the at least one processor to perform the operations of: a memory; and at least one processor that is operatively coupled to the memory, the at least one processor being configured to perform the operations of: obtaining a plurality of measured response times for a given storage group, each of the measured response times corresponding to a different instance of a same time window; classifying the plurality of measured response times with a machine learning model to obtain a first predicted response time and a second predicted response time, the first predicted response time corresponding to a first future instance of the time window, and the second predicted response time corresponding to a second future instance of the time window; detecting whether the first predicted response time and the second predicted response time satisfies a service level objective for the given storage group; and generating a notification when at least one of the first predicted response time and the second predicted response time fails to satisfy the service level objective.

### BRIEF DESCRIPTION OF THE DRAWING FIGURES

Other aspects, features, and advantages of the claimed invention will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features.

FIG. 1 is a diagram of an example of a system, according to aspects of the disclosure;

FIG. 2 is a diagram of an example of a storage system, according to aspects of the disclosure;

FIG. 3A is a diagram of an example of a service level objective database, according to aspects of the disclosure;

FIG. 3B is a diagram of an example of an alert register 158, according to aspects of the disclosure;

FIG. 4 is a diagram of an example of data used for training a machine learning model, as well as the output of the machine learning model, according to aspects of the disclosure;

FIG. 5 is a flowchart of an example of an incoming load vector, according to aspects of the disclosure;

FIG. 6 is a flowchart of an example of an incoming load vector, according to aspects of the disclosure;

FIG. 7 is a flowchart of an example of a user interface, according to aspects of the disclosure; and

FIG. 8 is a diagram of an example of a computing device, according to aspects of the disclosure.

### DETAILED DESCRIPTION

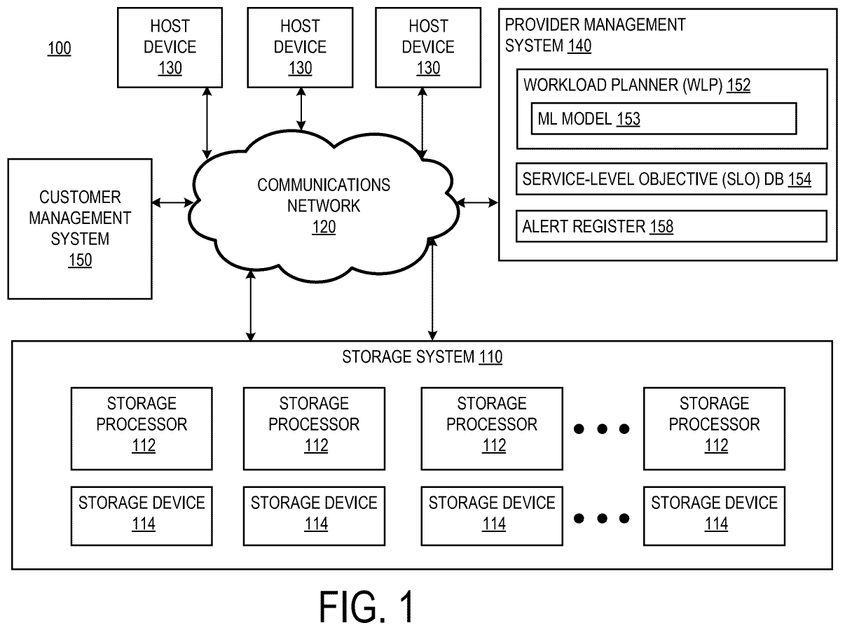

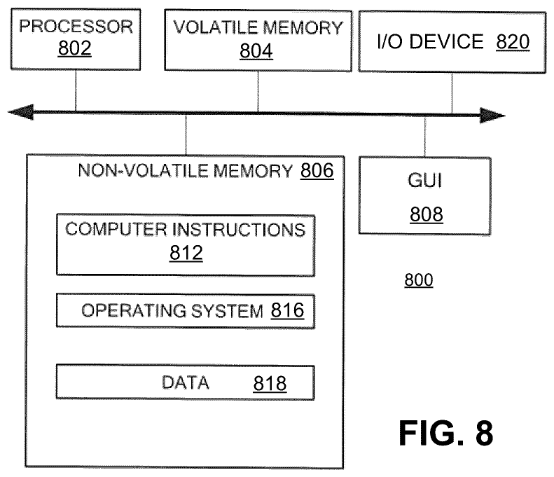

FIG. 1 is a diagram of an example of a system 100, according to aspects of the disclosure. As illustrated, system 100 may include a storage system 110, a plurality of host devices 130, a provider management system 140 (hereinafter “management system 140”), and a customer management system 150 (hereinafter “management system 150”). Storage system 110, host devices 130, management system 140, and management system 150 may be coupled to each other via a network network 120. Network 120 may include one or more of a fibre channel (FC) network, the Internet, a local area network (LAN), a wide area network (WAN), and/or any other suitable type of network. The storage system 110 may include a storage system, such as DELL/EMC Powermax™, DELL PowerStore™, and/or any other suitable type of storage system. The storage system 110 may include a plurality of storage devices 114 and a plurality of storage processors 112. Each of the storage processors 112 may include a computing device, such as the computing device 800, which is discussed further below with respect to FIG. 8. Each of the storage processors 112 may be configured to receive I/O requests from host devices 130 and execute the received I/O requests by reading and/or writing data to storage devices 114. Each of the host devices 130 may include a desktop computer, a laptop, a smartphone, an internet-of-things (IoT) device, and/or any other suitable type of computing device. According to the present example, each of storage devices 114 is a solid-state drive (SSD). However, alternative implementations are possible in which any of storage devices 114 is a different type of storage device, such as a hard disk or a non-volatile random-access memory (NVRAM) device.

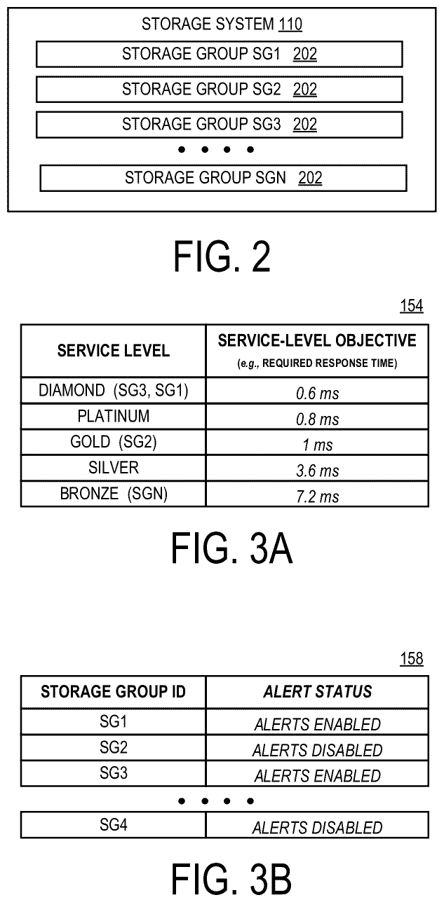

As illustrated in FIG. 2, storage system 110 may be configured to host a plurality of storage groups 202. In the present example, storage groups 202 are enumerated as storage group SG1 through storage group SGN. In one example, any of the storage groups 202 may include one or more data volumes that are hosted on storage devices 114. In another example, any of the storage groups 202 may be a logical grouping of thin devices that are provisioned with a particular application. It will be understood that the present disclosure is not limited to any specific implementation of any of the storage groups 202.

Returning to FIG. 1, storage system 110 may be configured to provide storage space to various customers. In this regard, management system 150 is an example of a management system on the customer side which is used to manage various settings of a storage group that corresponds to the customer (e.g., one of storage groups 202). Management system 150 may include one or more computing devices, such as the computing device 800, which is discussed further below with respect to FIG. 8.

Management system 140 is an example of a management system that is part of storage system 110 and which is used to manage storage system 110 internally. The difference between management system 140 and management system 150 is that management system 140 may be operated by the owner of storage system 110 while management system 150 may be operated by a customer. In this regard, management system 150 may be configured to exert much greater control over the workings of storage system 110. In some implementations, management system 140 may include one or more computing devices, such as the computing device 800, which is discussed further below with respect to FIG. 8.

According to the present example, management system 140 is configured to execute a workload planner (WLP) 152, a service level objective (SLO) database 154 (hereinafter “database 154”), and an alert register 158. However, it will be understood that in many practical applications, management system 140 may be arranged to execute additional software, such as software for the management of snapshots and data replication for example. It will be understood that the present disclosure is not limited to any specific implementation of management system 140.

WLP 152 may include a utility that is arranged to predict the response time of a storage group that is hosted in storage system 110. The term “response time” as used herein refers to the amount of time it takes a storage group to respond to a request for service. The present disclosure is not limited to any specific way of measuring response time. In one example, the response time of a storage group may be the duration of the period starting when a request an I/O request is received by storage system 110 and ending when the I/O request is completed by storage system 110. As another example, the response time may be the duration of the period starting when a host device 130 transmits an I/O request to storage system 110 and ending when the host device 130 determines that the I/O request has been completed by storage system 110.

WLP 152 may include a machine learning model 153 (hereinafter “model 153”). According to the present example, model 153 includes a neural network. The neural network may include any suitable type of neural network. By way of example, the neural network may be a feedforward neural network (FNN), a convolutional neural network (CNN), a recurrent neural network (RNN), and/or any other suitable type of neural network. Although, in the present example, model 153 includes a neural network, alternative implementations are possible in which model 153 includes a different type of machine learning model, such as a linear regression model or a Kaufman Adaptive Moving Average (KAMA) predictor.

Model 153 may be configured to receive as input a plurality of measured response times of a given storage group that is hosted by storage system 110 (e.g., one of storage groups 202 which is shown in FIG. 2). Each of the plurality of measured response times may correspond to a different instance of the same time period. For example, a first one of the measured response times may be the response time of the given storage group in the period between 12:00 p.m. and 4:00 p.m. on Monday, Jul. 1, 2024; a second one of the measured response times may be the response time of the given storage group in the period between 12:00 p.m. and 4:00 p.m. on Monday, July 8th, 2024; a third one of the of the measured response times may be the response time of the given storage group in the period between 12:00 p.m. and 4:00 p.m., and so forth. In other words, under the nomenclature of the present disclosure, a period is defined by start time, end time, and day of the week. So, for example, a time interval between 1:00 and 4:00 p.m. on Monday would be considered a different period from a time interval between 1:00 and 4:00 p.m. on Tuesday. On the other hand the time intervals between 1:00 and 4:00 p.m. on two different Mondays would be considered different instances of the same time window. Under the nomenclature of the present disclosure, the plurality of measured response times is also referred to as a “response time signature of a time window”. In some implementations, a period may be defined by date, rather than a day of the week, and/or based on a different calendrical measure.

In some implementations, each of the plurality of measured response times may be a weighted average response time. For example, any of the plurality of measured response times may be calculated as follows. First, the WLP 152 may collect a plurality of response time samples RTᵢ. Next, for each of the response time samples, WLP 152 may determine the load (measured in IOPS) which storage system 110 was under when the response time sample was recorded. And finally, WLP 152 may calculate the weighted average of the response time samples, in accordance with equations 1 and 2 below:

$$WRT = \frac{{\sum }_{i = 1}^{n} ( {RT}_{i} + {WT}_{i} )}{{\sum }_{i = 1}^{n} {WT}_{i}} \qquad ( 1 )$$

$${WT}_{i} = {RT}_{i} * {LOAD}_{i} \qquad ( 2 )$$

Where RTᵢ is the i-th response sample in the plurality, LOAD; is the load that the given storage group was under when sample RTi was recorded, and WRT is the weighted average response time.

The response time samples RTᵢ may be calculated at 5-minute intervals (or intervals having a different duration). Each of the response time samples may be the response time of one I/O operation that was executed for the given storage group during the sample's corresponding 5-minute period. Alternatively, each response time sample may be calculated by taking the average of the response times of a plurality of response I/O operations that were executed for the given storage group. The present disclosure is not limited to any specific method for taking (or calculating) response time measurements. The term I/O operation may refer to a read request, a write request, and/or any other suitable type of I/O operation.

In some implementations, in addition to the response time signature for a time window, the input to model 153 may include additional information, such as an identifier of the time window that corresponds to the response signature. Additionally or alternatively, in some implementations, the input to model 153 may include a plurality of time period instance identifiers, wherein each time period instance identifier uniquely identifies a different one of the time period instances that are associated with the plurality of measured response times.

Model 153 may be configured to output one or more predicted response times. Each predicted response time may correspond to the same time window as the plurality of measured response times which are received as input by model 153 and used as a basis for the generation of the predicted response times. So, for example, if each of the measured response times corresponds to a different instance of the period starting at 12:00 p.m. and ending at 4:00 p.m. on Monday, each of the predicted response times would be the response time which the given storage group is expected to have between 12:00 p.m. and 4:00 p.m. on a different Monday in the future. For example, a first one of the predicted response times may correspond to a first Monday in the future, a second one of the predicted response time may correspond to a second Monday in the future, and so forth. Although, in the present example, the response time signature includes observed response times for the period whose response time is being predicted, it will be understood that in other implementations the response time signature may include the response times for other periods as well.

In some implementations, model 153 may be trained by using a supervised training algorithm. Model 153 may be trained on training data including a plurality of training data items. Each training data item may include a different response time signature and a corresponding label, which identifies a corresponding response time. In some implementations, model 153 may be trained on data that is associated with different storage groups in storage system 110.

FIG. 3A is a diagram of an example of database 154, according to one implementation. Database 154 may include one or more data structures that are configured to identify the SLO for each of the storage groups 202 that are hosted by storage system 110. According to the present example, storage groups SG1 and SG3 have an SLO of 0.6 ms, storage group SG2 has an SLO of 1 ms, and storage group SGN has an SLO of 7.2 ms. In another aspect, FIG. 3A illustrates that each of the storage groups 202 may be associated with a respective service plan. In the present example, the service level plans are labeled diamond, platinum, gold, silver, and bronze, respectively, and they are associated with different SLOs. As can be readily appreciated, plans that have a lower SLO might cost more for subscribers to use, and the provider of storage system 110 might be under a legal obligation to satisfy the plans' respective service objectives. As is discussed further below, WLP 152 may be configured to proactively detect whether a storage group would be able to satisfy its SLO in the future. If the SLO is determined to be unlikely to satisfy its SLO in the future, the WLP 152 may generate an alert which would ideally make a system administrator aware of the impending problem.

FIG. 3B is a diagram of an example of alert register 158, according to aspects of the disclosure. As illustrated, alert register 158 may include a plurality of entries (depicted as table rows). Each entry may include an identifier of a different storage group 202 and an indication of whether alerts for that storage group are enabled. If the alerts for a storage group 202 are enabled, WLP 152 may generate an alert whenever it has determined that the storage group 202 is predicted to fail to meet its SLO during a particular time period. By contrast, if the alerts are not enabled, WLP 152 may refrain from generating alerts that indicate that the storage group 202 would likely fail to meet its SLO.

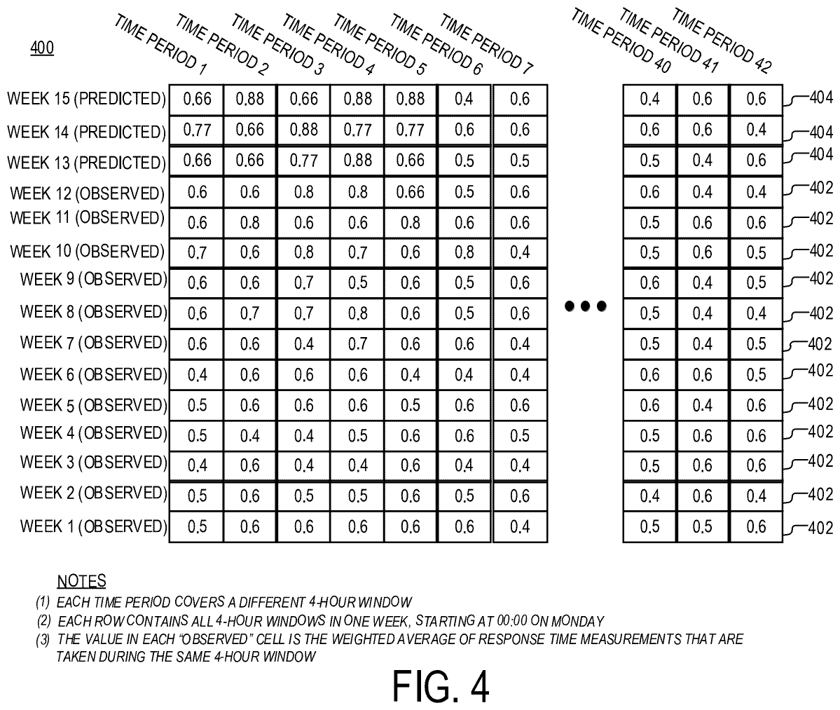

FIG. 4 is a diagram of an example of a data set 400, according to aspects of the disclosure. For ease of description, the data set 400 is presented in a table including rows 402 and 404. Each of rows 402 and 404 includes as many cells as there are consecutive non-overlapping 4-hour periods in a week. Each cell in rows 402 corresponds to the response time of a given storage group (e.g., storage group SG1 shown in FIG. 2) that is measured (or otherwise observed) during the time window that corresponds to the cell. As noted above, the response time may be a weighted average response time calculated in accordance with equations 1 and 2, and/or any other suitable measure of response time. Each cell in rows 404 corresponds to the response time the given storage group (e.g., storage group SG1 shown in FIG. 2) is predicted to have in the future, during the cell's corresponding time window. In the present example, the cells that correspond to weeks 1-12 contain measured (or otherwise observed) response time values for the given storage group. The cells that correspond to weeks 13-15 contain response time values that are generated by machine learning model 153 as a result of executing machine learning model 153 based on at least some of the data in the cells that correspond to weeks 1-12. In one example, the response time values for Time Period 1 in weeks 13-15 may be generated based on the observed response times during Time Period 1 in weeks 1-12 (i.e., the values in the top three cells of the leftmost row of the table can be generated, at least in part, based on the remaining values in the leftmost row. In another example, the response time values for Time Period 1 in weeks 13-15 may be generated based on the observed response times during Time Periods 1-42 in weeks 1-12 (i.e., the values in the top three cells of the leftmost row of the table can be generated, at least in part, based on the observed response times for all time periods, rather than Time Period 1 only).

The present disclosure is not limited to any specific configuration of machine learning model 153. As noted above, the machine learning model 153 may receive input data and generate output data based on the input data. The output data may include one or more predicted response times (of a storage group) for the same time period. Alternatively, the output data may include a different respective set of one or more predicted response times (of the storage group) for each of a plurality of time periods. The input data may include a response time signature for a given time period, wherein the response time signature includes measured response times of the storage group. Furthermore, the input data may include an identifier of the storage group, an identifier of a particular time window for which predicted response times need to be obtained, etc. Additionally or alternatively, the input data may include a plurality of response time signatures, wherein each response time signature corresponds to a different time period and includes measured response times of the storage group during the time period. Additionally, in some implementations, the input data may include response time signatures for other storage groups that are hosted on the same storage system as the storage group whose response times are being predicted.

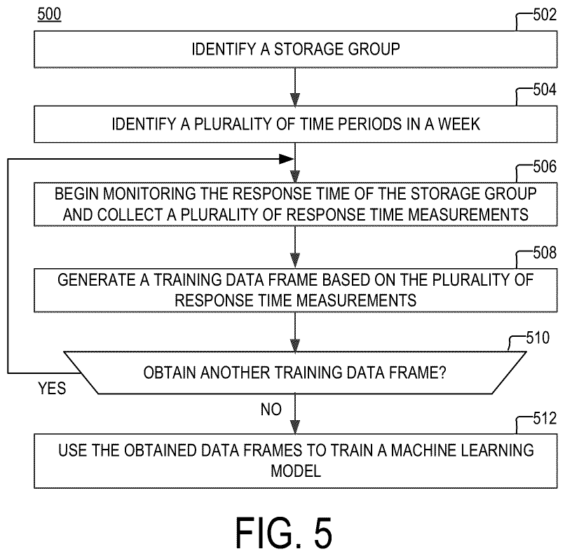

FIG. 5 is a flowchart of an example of a process 500, according to aspects of the disclosure.

At step 502, WLP 152 identifies a given storage group. The given storage group may be the same or similar to any of the storage groups 202 that are shown in FIG. 2. At step 504, WLP 152 identifies a plurality of time periods (or time windows) in a week. According to the present example, the time periods each have a duration of four hours, but the present disclosure is not limited to any specific duration. According to the present example, the time periods are non-overlapping. Furthermore, according to the present example, the identified plurality of time periods includes all 4-hour periods in a week, and it is identified by dividing the entire week into 4-hour periods.

At step 506, WLP 152 begins monitoring the response time of the given storage group (identified at step 502). As a result, WLP 152 collects a plurality of response time measurements that are taken at different time instants. In some implementations, the response time measurements may be taken over the course of an entire week (and/or over the course of the entire set of the periods identified at step 504).

At step 508, WLP 152 generates a training data frame based on response time measurements that are taken at step 506. The training data frame may include a plurality of values, wherein each of the values is the weighted average response time for a different one of the plurality of periods (identified at step 506). Each of the values may be calculated by using equations 1 and 2, which are discussed above. In some implementations, the training data frame may be the same or similar to one of rows 402, which is shown in FIG. 4.

At step 510, WLP 152 determines whether another set of response time signatures needs to be obtained. If another set of response time signatures needs to be obtained, process 500 returns to step 508. Otherwise, process 500 proceeds to step 512.

At step 512, WLP 152 trains the machine learning model 153 based on the sets of response signatures that are obtained at steps 508-510. In some implementations, the training may be performed in the manner discussed above.

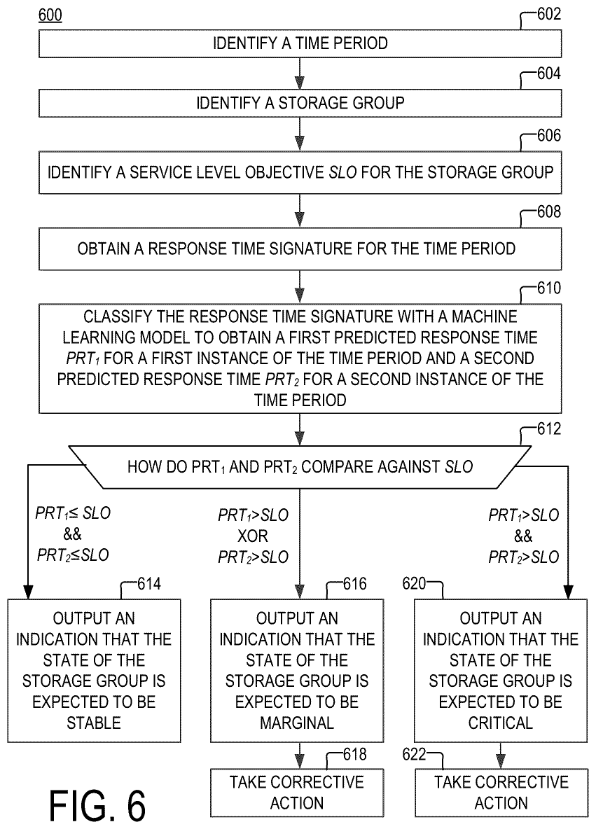

FIG. 6 is a flowchart of an example of a process 600, according to aspects of the disclosure.

At step 602, WLP 152 identifies (or selects) a time period. The identified time period may be the same as any of the periods discussed above. According to the present example, the identified period starts at 1 p.m. and ends at 5 p.m., on Monday.

At step 604, WLP 152 identifies (or selects) a storage group. The storage group may include one or more data volumes that are hosted in storage system 110 (e.g., data volumes stored on storage devices 114 of FIG. 1). The storage group may be the same or similar to any of the storage groups 202 which are discussed above with respect to FIG. 2.

At step 606, WLP 152 identifies a service level objective SLO for the storage group (identified at step 604). The service level objective may be identified by performing a search of a database, such as database 154 which is discussed above with respect to FIG. 3A.

At step 608, WLP 152 obtains a response time signature for the time period (identified at step 602). The response time signature may correspond to the storage group (identified at step 604). The response time signature may be the same or similar to the response time signature that is discussed above with respect to FIG. 1. The response time signature may include a plurality of values. Each value may be the weighted average response time of the storage group (identified at step 604) during a different instance of the time period (identified at step 602).

At step 610, WLP 152 classifies the response time signature (obtained at step 608) with the machine learning model 153. As a result of classifying the signature, WLP 152 may obtain a first predicted response time PRT₁ and a second predicted response time PRT₂. Predicted response time PRT₁ may be the response time that the storage group (identified at step 604) is expected to have during a first instance of the time period (identified at step 602). Predicted response time PRT₂ may be the response time that the storage group (identified at step 604) is expected to have during a second instance of the time period (identified at step 602). According to the present example, the first instance of the time period is the window that starts at 1 p.m. and ends at 5 p.m. on Monday, Jul. 8, 2024. According to the present example, the second instance of the time period is the window that starts at 1 p.m. and ends at 5 p.m. on Monday, Jul. 15, 2024. According to the present example, both July 8th and July 15th are in the future, relative to the time when process 600 is executed.

At step 612, WLP 152 determines how the response times PRT₁ and PRT₂ (determined at step 610) compare against the service level object SLO (obtained at step 606). If each of response times PRT₁ and PRT₂ is less than or equal to the service level objective SLO, process 600 proceeds to step 614. If only one (but not both) of response times PRT₁ and PRT₂ is greater than the service level objective SLO, process 600 proceeds to step 616. If both response times PRT₁ and PRT₂ are greater than the service level objective SLO, process 600 proceeds to step 620.

At step 614, WLP 152 outputs an indication that the state of the storage group (identified at step 604) is expected to be stable during the time period (identified at step 604). By way of example, outputting the indication may include one or more of displaying the indication on a display of the management system 140 or transmitting the indication over network 120 to the customer management system 150.

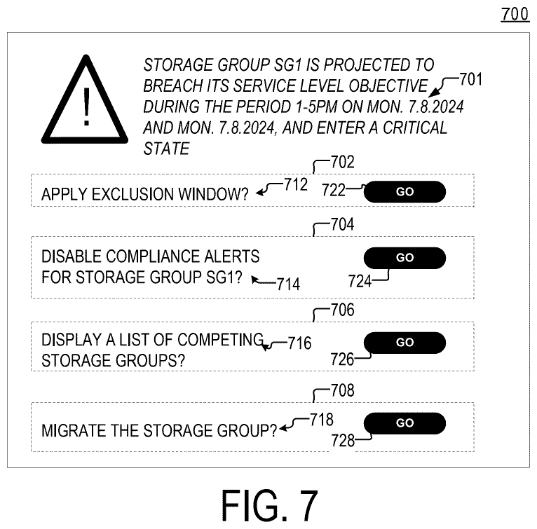

At step 616, WLP 152 outputs an indication that the state of the storage group (identified at step 604) is expected to be marginal during the time period (identified at step 602). By way of example, output the indication may include one or more of displaying the indication on a display of the management system 140 or transmitting the indication over network 120 to the customer management system 150. Additionally or alternatively, in some implementations, outputting the indication may include displaying a user interface screen 700, which is discussed further below with respect to FIG. 7.

At step 618, WLP executes a corrective action. In one example, the corrective action may include increasing the service level objective for the storage group (identified at step 604). As can be readily appreciated, increasing the service level objective may prevent any future alerts being issued for the storage group. Additionally or alternatively, the corrective action may include migrating the storage group from one RAID array (where it is currently hosted) to a different RAID array. Additionally or alternatively, the corrective action may include migrating the storage group from storage system 110 to a different storage system. Additionally or alternatively, the corrective action may include any of the actions that are discussed further below with respect to FIG. 7.

At step 620, WLP 152 outputs an indication that the state of the storage group (identified at step 604) is expected to be critical during the time period (identified at step 604). By way of example, output the indication may include one or more of displaying the indication on a display of the management system 140 or transmitting the indication over network 120 to the customer management system 150. Additionally or alternatively, in some implementations, outputting the indication may include displaying a user interface screen 700, which is discussed further below with respect to FIG. 7.

At step 622, WLP executes a corrective action. In one example, the corrective action may include increasing the service level objective for the storage group (identified at step 604). As can be readily appreciated, increasing the service level objective may prevent any future alerts being issued for the storage group. Additionally or alternatively, the corrective action may include migrating the storage group from one RAID array (where it is currently hosted) to a different RAID array. Additionally or alternatively, the corrective action may include migrating the storage group from storage system 110 to a different storage system. Additionally or alternatively, the corrective action may include any of the actions that are discussed further below with respect to FIG. 7.

Under the nomenclature of the present example, a storage group is considered to be in a stable state when the storage group is operating as expected. The storage group is considered to be in a marginal state when the storage group is deviating from its normal operation but has not yet passed the line in which the deviation is considered serious. And the storage group is considered to be in a critical state when the deviation from its normal operation is considered serious. In other words, the terms “stable state”, “marginal state”, and “critical state” signal different levels of compliance (or lack thereof) with a service level objective.

FIG. 6 is provided as an example only. At least some of the steps discussed with respect to FIG. 6 can be performed in parallel, in a different order, or altogether omitted. In many practical applications, WLP 152 may be configured to generate a respective predicted response time for one or more instances of each of the 42 4-hour time periods that are present in a week (or another 7-day period). Moreover, WLP 152 may continuously measure the response times of different storage groups in storage system 110 and update the response time data set that is supplied to WLP 152 and used as a basis for generating the predicted response times. Although, in the example of FIG. 6, machine learning model 153 receives as input a single response time signature, in alternative implementations, model 153 may receive as input (at once) a plurality of response time signatures, wherein each response time signature corresponds to a different time period. In such implementations, machine learning model 153 may output (at once) one or more respective predictions for each of the time periods. Although, in the present example, the time periods have a 4-hour duration, in alternative implementations they may have a different duration. Although, in the example of FIG. 6, predictions are rendered for two consecutive weeks in the future, alternative implementations are possible when predictions are rendered for only one week in the future or for more than two weeks in the future. In such implementations, whenever the prediction for a given time period is above the service level objective of the storage group, an alert may be issued that notifies the user that service level objective is expected to be violated.

FIG. 7 is a diagram of an example of a user interface screen 700, according to aspects of the disclosure. As illustrated, the user interface screen 700 includes a message 701 which indicates that the storage group (identified at step 604) is likely to experience a service level breach and enter the critical state. In addition, user interface screen 700 includes portions 702, 704, 706, and 708. Each of portions 702, 704, 706, and 708 is associated with a different corrective action and includes a respective “GO” button which, when pressed, would cause the corrective action to be executed. Although, in the present example, a button is provided to trigger the execution of any of the corrective actions, the present disclosure is not limited thereto. For example, in some implementations, any of the buttons may be replace with a different type of input component, such as a link or a text box. Furthermore, the plurality of “GO” buttons may be replaced with a single button in some implementations. Stated succinctly, the present disclosure is not limited to any specific configuration of the screen 700.

Portion 702 may include a label 712 and a button 722. Label 712 indicates that activating button 722 would cause an exclusion window to be applied to the period (identified at step 602). According to the present example, applying the exclusion window may include any action that causes WLP 152 to stop generating alerts for the time period (identified at step 602) while permitting WLP 152 to continue issuing alerts for other time periods in which the service level of the storage group (identified at step 604) is expected to be breached. In some implementations, applying the exclusion window may include removing, from a data set that is being fed to WLP 152, information that is associated with the period (identified at step 602). Removing the data may prevent a new alert from being generated next time when WLP 152 is executed to obtain new predictions. Additionally or alternatively, applying the exclusion window may include inserting in alert register 158 an indication that no alerts need to be generated for the time period (identified at step 602)

Portion 704 may include a label 714 and a button 724. Label 714 indicates that activating button 722 would cause WLP 152 to disable compliance alerts for the storage group (identified at step 604). Disabling the compliance alerts may include performing a search of alert register 158 to identify the entry that corresponds to the storage group and modifying the entry to indicate that alerts are disabled for the storage group.

Portion 706 may include a label 716 and a button 726. Label 716 indicates that activating button 726 would cause WLP 152 to display a list of other storage groups that compete for the resources of storage system 110 with the storage group that is identified at step 604. The other storage groups may also be hosted on storage system 110. The other storage groups may compete with the storage group (identified at step 604) for CPU time, random access memory, and/or any other suitable type of resource. As can be readily appreciated, the competition for resources with the other storage groups may be what causes the expected response time of the storage group (identified at step 604) to breach the service level objective for the storage group. In this regard, displaying the list may allow system administrators to adjust the priority settings of the other storage group to enable greater access to system resources for the storage group (identified at step 604). Displaying the list of competing storage groups may include displaying the list on a display screen of management system 150 and/or transmitting the list, over network 120, to management system 140 (where it can be displayed locally to the customer).

Portion 708 may include a label 718 and a button 728. Label 718 indicates that activating button 728 would cause WLP 152 to migrate the storage group (identified at step 604) from storage system 110 to a different storage system, or from one RAID array (where it is currently hosted) to a different RAID array.

A description is now provided of three use cases for WLP 152.

### Use Case 1

The state of a given storage group is currently stable. However, a system administrator notices that the response time of the given storage group is increasing. The system administrator executes WLP 152 to generate a first set of predicted values for a first 7-day period and a second set of predicted values for the next 7-day period. The first 7-day period starts roughly when the machine learning model is executed and ends seven days later. The second 7-day period follows the first 7-day period. The first set of predicted values includes a different respective predicted response time (e.g., weighed average response time, etc.) for each of the 42 4-hour periods in the first 7-day period. The first set of predicted values includes a different respective predicted response time (e.g., weighed average response time, etc.) for each of the 42 4-hour periods in the second 7-day period. Each of the time periods may be the same as the time periods discussed above with respect to FIG. 4. If any given one of the values in the first set is above the service level objective for the given storage group, WLP 152 may generate an alert that the state of the given storage group is expected to be marginal. If the projected response time in the second set of values, which corresponds to the same time window as the given value from the first set, is also above the service level objective, WLP 152 may generate an alert that the state of the give storage group is projected to be critical. In both cases, the alert may be displayed on the display of management system 140 or another display device, such as the display device of management system 150.

### Use Case 2

The state of a given storage group is currently critical. However, a system administrator notices that the response time of the given storage group is decreasing. The system administrator executes WLP 152 to generate a first set of predicted values for a first 7-day period and a second set of predicted values for the next 7-day period. The first 7-day period starts roughly when the machine learning model is executed and ends seven days later. The second 7-day period follows the first 7-day period. The first set of predicted values includes a different respective predicted response time (e.g., weighed average response time, etc.) for each of the 42 4-hour periods in the first 7-day period. The first set of predicted values includes a different respective predicted response time (e.g., weighed average response time, etc.) for each of the 42 4-hour periods in the second 7-day period. Each of the time periods may be the same as the time periods discussed above with respect to FIG. 4. If the values in the first set that correspond to time periods whose current response times exceed the service level objective are less than the service level objective, WLP 152 may generate an alert that the state of the given storage group is expected to become marginal. If the values in both the first set and the second set that correspond to time periods whose current response times exceed the service level objective are less than the service level objective, WLP 152 may generate an alert that the state of the given storage group is expected to become stable. In both cases, the alert may be displayed on the display of management system 140 or another display device, such as the display device of management system 150.

### Use Case 3

The state of a given storage group is projected to be marginal or critical by WLP 152. A system administrator analyzes the data that is used as a basis for the prediction by WLP 152 and determines that the data is anomalous. The system administrator then performs a further analysis on the data to determine when the part of the data that is anomalous will clear for the compliance calculation window. Performing this analysis may provide the system administrator with greater clarity over the operations of the storage system and enable him or her to manage the storage system more efficiently.

Referring to FIG. 8, in some embodiments, a computing device 800 may include processor 802, volatile memory 804 (e.g., RAM), non-volatile memory 806 (e.g., a hard disk drive, a solid-state drive such as a flash drive, a hybrid magnetic and solid-state drive, etc.), graphical user interface (GUI) 808 (e.g., a touchscreen, a display, and so forth) and input/output (I/O) device 820 (e.g., a mouse, a keyboard, etc.). Non-volatile memory 806 stores computer instructions 812, an operating system 816 and data 818 such that, for example, the computer instructions 812 are executed by the processor 802 out of volatile memory 804. Program code may be applied to data entered using an input device of GUI 808 or received from I/O device 820.

FIGS. 1-8 are provided as an example only. In some embodiments, the term “I/O request” or simply “I/O” may be used to refer to an input or output request. In some embodiments, an I/O request may refer to a data read or write request. At least some of the steps discussed with respect to FIGS. 1-6 may be performed in parallel, in a different order, or altogether omitted. As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used throughout the disclosure, the term “vector” refers to a sequence of numbers (and/or other elements). The phrase “the element having index i” refers to the i-th element in the sequence. For example, if i=1, the phrase i-th element in the sequence would refer to the first element in the sequence, if i=2, the phrase i-th element in the sequence would refer to the second element in the sequence, and so forth.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

To the extent directional terms are used in the specification and claims (e.g., upper, lower, parallel, perpendicular, etc.), these terms are merely intended to assist in describing and claiming the invention and are not intended to limit the claims in any way. Such terms do not require exactness (e.g., exact perpendicularity or exact parallelism, etc.), but instead it is intended that normal tolerances and ranges apply. Similarly, unless explicitly stated otherwise, each numerical value and range should be interpreted as being approximate as if the word “about”, “substantially” or “approximately” preceded the value of the value or range.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

While the exemplary embodiments have been described with respect to processes of circuits, including possible implementation as a single integrated circuit, a multi-chip module, a single card, or a multi-card circuit pack, the described embodiments are not so limited. As would be apparent to one skilled in the art, various functions of circuit elements may also be implemented as processing blocks in a software program. Such software may be employed in, for example, a digital signal processor, micro-controller, or general-purpose computer.

Some embodiments might be implemented in the form of methods and apparatuses for practicing those methods. Described embodiments might also be implemented in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the claimed invention. Described embodiments might also be implemented in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the claimed invention. When implemented on a general-purpose processor, the program code segments combine with the processor to provide a unique device that operates analogously to specific logic circuits. Described embodiments might also be implemented in the form of a bitstream or other sequence of signal values electrically or optically transmitted through a medium, stored magnetic-field variations in a magnetic recording medium, etc., generated using a method and/or an apparatus of the claimed invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term “compatible” means that the element communicates with other elements in a manner wholly or partially specified by the standard and would be recognized by other elements as sufficiently capable of communicating with the other elements in the manner specified by the standard. The compatible element does not need to operate internally in a manner specified by the standard.

It will be further understood that various changes in the details, materials, and arrangements of the parts which have been described and illustrated in order to explain the nature of the claimed invention might be made by those skilled in the art without departing from the scope of the following claims.

1. A method, comprising:
obtaining a plurality of measured response times for a given storage group, each of the measured response times corresponding to a different instance of a same time window;
classifying the plurality of measured response times with a machine learning model to obtain a first predicted response time and a second predicted response time, the first predicted response time corresponding to a first future instance of the time window, and the second predicted response time corresponding to a second future instance of the time window;
detecting whether the first predicted response time and the second predicted response time satisfies a service level objective for the given storage group; and
generating a notification when at least one of the first predicted response time and the second predicted response time fails to satisfy the service level objective.

2. The method of claim 1, wherein generating the notification includes generating an indication that a compliance of the given storage group with the service level objective is expected to be marginal, when only one of the first predicted response time and the second predicted response time fails to satisfy the service level objective.

3. The method of claim 1, wherein generating the notification includes generating an indication that a compliance of the given storage group with the service level objective is expected to be critical, when both of the first predicted response time and the second predicted response time fail to satisfy the service level objective.

4. The method of claim 1, further comprising taking a corrective action when at least one of the first predicted response time and the second predicted response time fails to satisfy the service level objective, the corrective action including increasing a value of the service level objective.

5. The method of claim 1, further comprising taking a corrective action when at least one of the first predicted response time and the second predicted response time fails to satisfy the service level objective, the corrective action including migrating the given storage group to a different storage array.

6. The method of claim 1, wherein each of the plurality of measured response times is calculated by collecting a plurality of response time samples during a corresponding time window instance and calculating a weighted average of the response time samples, the weighted average being calculated by weighting each of the response time samples based on a current load on the given storage group when the response time sample was taken.

7. The method of claim 1, wherein the given storage group includes one or more data volumes.

8. The method of claim 1, wherein outputting the notification includes displaying a user interface window that includes an offer to exclude the time window from further monitoring.

9. The method of claim 1, wherein outputting the notification includes displaying a user interface window that includes an offer to deregister compliance alerts for the given storage group.

10. The method of claim 1, wherein outputting the notification includes displaying a user interface window that identifies one or more other storage groups that compete with the given storage group for storage system resources and are given a higher priority than the given storage group for using the storage system resources.

11. A system, comprising:
a memory; and
at least one processor that is operatively coupled to the memory, the at least one processor being configured to perform the operations of:
obtaining a plurality of measured response times for a given storage group, each of the measured response times corresponding to a different instance of a same time window;
classifying the plurality of measured response times with a machine learning model to obtain a first predicted response time and a second predicted response time, the first predicted response time corresponding to a first future instance of the time window, and the second predicted response time corresponding to a second future instance of the time window;
detecting whether the first predicted response time and the second predicted response time satisfies a service level objective for the given storage group; and
generating a notification when at least one of the first predicted response time and the second predicted response time fails to satisfy the service level objective.

12. The system of claim 11, wherein generating the notification includes generating an indication that a compliance of the given storage group with the service level objective is expected to be marginal, when only one of the first predicted response time and the second predicted response time fails to satisfy the service level objective.

13. The system of claim 11, wherein generating the notification includes generating an indication that a compliance of the given storage group with the service level objective is expected to be critical, when both of the first predicted response time and the second predicted response time fail to satisfy the service level objective.

14. The system of claim 11, wherein the at least one processor is further configured to take a corrective action when at least one of the first predicted response time and the second predicted response time fails to satisfy the service level objective, the corrective action including increasing a value of the service level objective.

15. The system of claim 11, wherein the at least one processor is further configured to take a corrective action when at least one of the first predicted response time and the second predicted response time fails to satisfy the service level objective, the corrective action including migrating the given storage group to a different storage array.

16. A non-transitory computer-readable medium storing one or more processor executable instructions, which, when executed by at least one processor, cause the at least one processor to perform the operations of:
a memory; and
at least one processor that is operatively coupled to the memory, the at least one processor being configured to perform the operations of:
obtaining a plurality of measured response times for a given storage group, each of the measured response times corresponding to a different instance of a same time window;
classifying the plurality of measured response times with a machine learning model to obtain a first predicted response time and a second predicted response time, the first predicted response time corresponding to a first future instance of the time window, and the second predicted response time corresponding to a second future instance of the time window;
detecting whether the first predicted response time and the second predicted response time satisfies a service level objective for the given storage group; and
generating a notification when at least one of the first predicted response time and the second predicted response time fails to satisfy the service level objective.

17. The non-transitory computer-readable medium of claim 16, wherein generating the notification includes generating an indication that a compliance of the given storage group with the service level objective is expected to be marginal, when only one of the first predicted response time and the second predicted response time fails to satisfy the service level objective.

18. The non-transitory computer-readable medium of claim 16, wherein generating the notification includes generating an indication that a compliance of the given storage group with the service level objective is expected to be critical, when both of the first predicted response time and the second predicted response time fail to satisfy the service level objective.

19. The non-transitory computer-readable medium of claim 16, wherein the one or more processor executable instructions, when executed by the at least one processor, further cause the at least one processor to perform the operation of a corrective action when at least one of the first predicted response time and the second predicted response time fails to satisfy the service level objective, the corrective action including increasing a value of the service level objective.

20. The non-transitory computer-readable medium of claim 16, wherein the one or more processor executable instructions, when executed by the at least one processor, further cause the at least one processor to perform the operation of taking a corrective action when at least one of the first predicted response time and the second predicted response time fails to satisfy the service level objective, the corrective action including migrating the given storage group to a different storage array.
